(19) United States
(12) Patent Application Publication
(10) Pub. No.: US 2007/0141523 A1
(43) Pub. Date: Jun. 21, 2007

(54) Sintering furnace for pipe fittings

(76) Inventor: Ye-Long Su, Taipei (TW)

Correspondence Address: LEONG C LEI, PMB # 1008, 1867 YGNACIO VALLEY ROAD, WALNUT CREEK, CA, 94598, US

(21) Appl. No.: 11/305,234

(22) Filed: Dec. 19, 2005

(51) Int. Cl. F27B 3/20

(52) U.S. Cl. 432/175

(57) ABSTRACT

A sintering furnace for pipe fittings which includes an upper portion and a lower portion, a heater closely engaged with the upper portion of the sintering furnace, a sintering chamber arranged below the heater, an airtight seat mounted on a bottom of the sintering furnace, and an auxiliary heat separation layer mounted on an outer surface of the sintering chamber for keeping temperature of the sintering chamber.

### BACKGROUND OF THE INVENTION

(a) Field of the Invention

The present invention relates to a sintering furnace for pipe fittings and in particular to one which has improved airtight and heat separation abilities thereby causing pipe fittings to be heated evenly and enhancing the accuracy in the heating process, and therefore providing the pipe fittings with better conductivity and decreasing the maintenance cost.

(b) Description of the Prior Art

In order to provide better conductivity, it has been proposed to apply copper powder on the inner surface of the pipe fitting. If the copper powder is evenly applied to the inner surface of the pipe fitting, the heat dissipation ability of the pipe fitting will be highly improved. The copper powder is applied to the inner surface of the pipe fitting by heating to an appropriate temperature so that the copper powder will melt and will be able to flow to all portions of the pipe fitting. If the temperature is too high, the copper powder will be concentrated into a body, and if the temperature is too low, the copper powder cannot be adhered to the inner surface of the pipe fitting. In order to sinter the copper powder evenly on the inner surface of the pipe fitting, it is necessary to keep the temperature at an accurate value and the pipe fitting must be placed in a place with a steady and constant temperature.

The conventional sintering furnace for pipe fittings is used for receiving pipe fittings and transferring the pipe fittings to the heater for heating. The bottom portion of the sintering furnace is closed to the heating source of the heater so that the airtight device disposed at the bottom portion of the sintering furnace will be easily damaged by overheating thereby failing the heating process of the pipe fittings. Hence, it has been proposed to arrange a heat separation layer on the bottom of the sintering furnace. However, since the sintering chamber is in direct contact with the body of the heater, the airtight device will generally be unable to provide satisfactory airtight effect due to the fact that the airtight device cannot endure high temperature. Furthermore, the leakage of inert gas (or special gas) will consume the airtight material thereby increasing the difficulties in maintenance. Moreover, the heating space within the sintering furnace is not airtight, the heat will be lost seriously in high temperature thus making it very difficult to accurately control the temperature in the sintering furnace.

Therefore, it is an object of the present invention to provide an improvement in the structure of a sintering furnace which can obviate and mitigate the above-mentioned drawbacks.

### SUMMARY OF THE INVENTION

This invention is related to an improvement in the structure of a sintering furnace for pipe fittings.

It is the primary object of the present invention to provide a sintering furnace for pipe fittings which includes an airtight seat and an auxiliary heat separation layer for effectively preventing the high temperature from transferring to the airtight section thereby enabling the temperature in the sintering chamber to be accurately controlled and facilitating the maintenance and reducing the replacement cost.

It is another object of the present invention to provide a sintering furnace for pipe fittings which has an airtight seat arranged on the bottom of the furnace for increasing the distance between the airtight section and the heating source, so that the airtight section is not in direct contact with the heating source for increasing the airtight ability and controlling the temperature of the sintering furnace accurately.

It is still another object of the present invention to provide a sintering furnace for pipe fittings which has a heat separation layer mounted on the outer lower surface of the sintering chamber so as to prevent the heat conductivity between the furnace and the airtight section thereby enabling the pipe fittings to be evenly heated.

According to the present invention, there is provided a sintering furnace for pipe fittings which includes an upper portion and a lower portion, a heater closely engaged with the upper portion of the sintering furnace, a sintering chamber arranged below the heater, an airtight seat mounted on a bottom of the sintering furnace, and an auxiliary heat separation layer mounted on an outer surface of the sintering chamber for keeping temperature of the sintering chamber.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a front view of the present invention;

FIG. 2 is a side view of the present invention; and

FIG. 3 is enlarged front view of the sintering chamber.

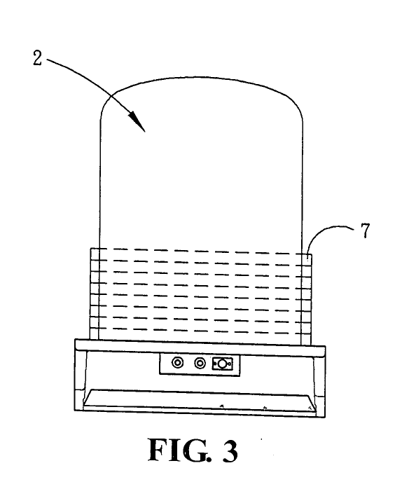

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

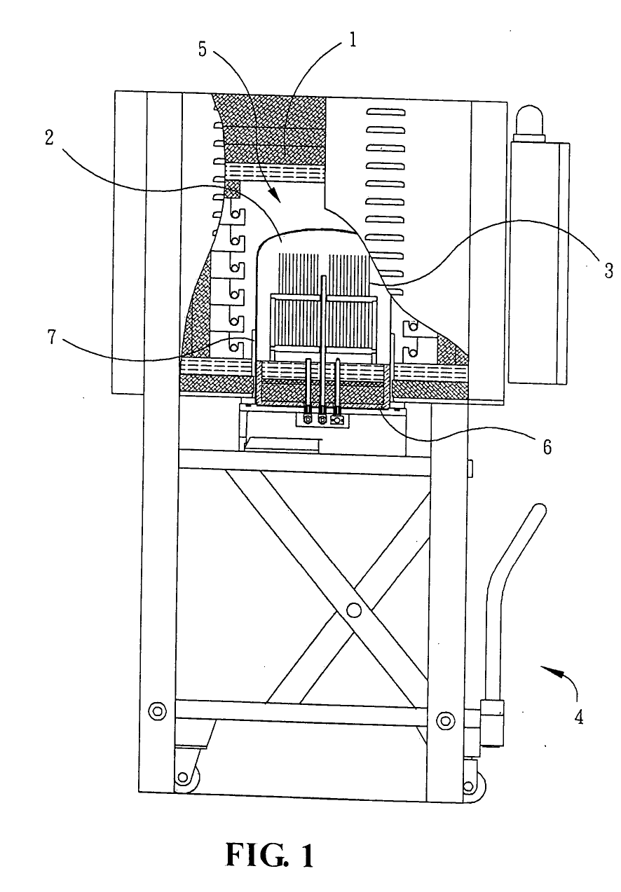

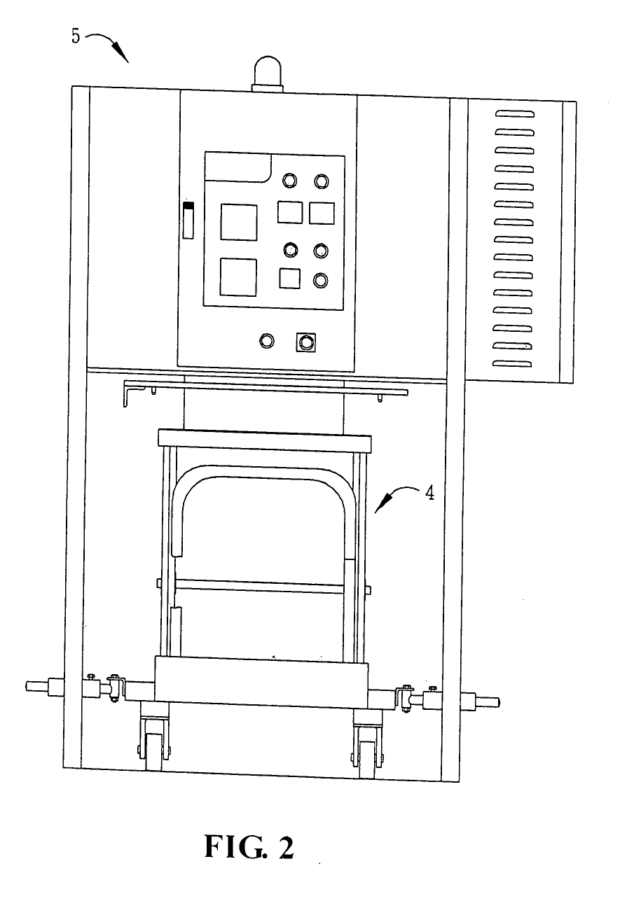

Referring to FIGS. 1 and 2, the sintering furnace 1 for pipe fittings according to the present invention comprises a sintering chamber 2 in which pipe fittings 3 are arranged and which is then airtight. Thereafter, the sintering chamber 2 is disposed on a cart 4 having a platform which will be raised to the position below the heater 5. Then, the sintering chamber 2 is raised into the heater 5. The bottom portion of the sintering furnace 1 is closely engaged with the upper portion of the heater 5 to keep an airtight effect.

The bottom of the sintering furnace 1 is provided with an airtight seat 6 which is not in direct contact with the heating source, so that the temperature in the sintering furnace 1 can be accurately controlled.

An auxiliary heat separation layer 7 is arranged on the bottom of the sintering chamber 2 for effectively preventing the high temperature from transferring from the sintering furnace 1 and the sintering chamber 2 to the airtight section of the airtight seat 6. Hence, the heat separation ability between the bottom of the heater 5 and the airtight section of the airtight seat 6 can be maintained and the heat conductivity can be reduced. In association with the airtight seat 6, the sintering furnace 1 will have between airtight ability and temperature control ability, thereby enabling the pipe fittings on the platform of the heater to be evenly heated.

The auxiliary heat separation layer 7 is flexible and can be evenly wound around the outer side of the bottom of the sintering chamber 2 to keep the heat separation ability between the sintering chamber 2 and the heater 5 and to maintain its airtight ability. As a consequence, the airtight material will not be damaged by high temperature and can be conveniently replaced and maintained when becoming hard.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A sintering furnace for pipe fittings comprising an upper portion and a lower portion, a heater closely engaged with said upper portion of said sintering furnace, a sintering chamber arranged below said heater, an airtight seat mounted on a bottom of said sintering furnace, and an auxiliary heat separation layer mounted on an outer surface of said sintering chamber for keeping temperature of said sintering chamber.

2. The sintering furnace for pipe fittings as claimed in claim 1, wherein
said airtight seat encloses a bottom of said sintering chamber.

3. The sintering furnace for pipe fittings as claimed in claim 1, wherein
said auxiliary heat separation layer is mounted on an outer lower side of said sintering chamber.
